(19) United States
(12) Patent Application Publication
(10) Pub. No.: US 2018/0057168 A1
(43) Pub. Date: Mar. 1, 2018

(54) Lateral linear moving curtain rail

(71) Applicant: Airbus Operations GmbH, Hamburg (DE)

(72) Inventors: Boris HOLTORF, Hamburg (DE); Gunter KYAS, Hamburg (DE)

(21) Appl. No.: 15/682,755

(22) Filed: Aug. 22, 2017

(30) Foreign Application Priority Data
Aug. 30, 2016 (EP) 16186258.6

(51) Int. Cl. B64D 11/00; A47H 1/06

(52) U.S. Cl. CPC B64D 11/0023; A47H 2001/045; A47H 1/06

(57) ABSTRACT

A vehicle cabin curtain rail attachment comprising a guiding rail configured to be mounted fixedly within a cabin and a movable curtain rail section to receive or guide a curtain, wherein the movable curtain rail section is configured to slide along the guiding rail to a desired position.

### CROSS-REFERENCES TO RELATED APPLICATIONS

This application claims the benefit of the European patent application No. 16186258.6 filed on Aug. 30, 2016, the entire disclosures of which are incorporated herein by way of reference.

### BACKGROUND OF THE INVENTION

The present invention relates to a vehicle cabin curtain rail attachment, which is suitable for use in an aircraft.

In a vehicle, in particular an aircraft, various equipment has to be installed within an interior space of the vehicle. For instance, electrical equipment, control components, oxygen supply for aircraft passengers and similar devices are installed behind linings or ceiling elements of the vehicle. These devices may be mounted to a structural component or an installation rail, using bolts, nuts, screws and/or similar fasteners. From time to time, maintenance work has to be done on these devices.

Whenever a customer airline decides to use a curtain rail for having the option to separate for example a galley area from a passenger area during catering, there are usually several options where to mount the curtain rail.

For example, according to a first option, the curtain rail is routed outboard of the aircraft related circuit breaker panel, the so called 2001VU. Then the curtain will be ending on the galley front or on the standard units and trolleys. This leads to the problem that the curtain would have to be opened, whenever the standard units or trolleys are being used.

For example, according to a second option the curtain rail is routed to the inboard wall next to the aircraft related circuit breaker panel, to the 2001VU, which is usually covered by a plexiglass cover. However, in case of failure, maintenance or for another reason, an electronic device behind the plexiglass cover has to be dismounted or exchanged, the plexiglass cover is usually not fully openable for access to the circuit breakers any more as the curtain rail is located just below the plexiglass cover. In this situation, the plexiglass cover will only open as far as until the plexiglass cover rests on the curtain rail. This in turn makes maintenance work complicated and time consuming. However, between two flights of an aircraft, the time for maintenance work is short.

U.S. Pat. No. 8,684,308 (B2) or EP 2 26 8 54 2 (B1) describes an arrangement for receiving a curtain rail for a curtain for partitioning at least two regions in a cabin of a vehicle, with a bottom facing the floor of the cabin, and a top facing the ceiling of the cabin, wherein the bottom is essentially planar and is designed to receive the curtain rail.

However, in case of maintenance, there is still the problem that the plexiglass cover cannot be opened such that enough space is available that the maintenance can be performed as short and as comfortable as possible.

### SUMMARY OF THE INVENTION

Thus, it is an object of the present invention to provide a curtain rail attachment that is easily and quickly taken outside a space needed for maintenance work and also moved back quickly after the maintenance work is finished.

A vehicle cabin curtain rail attachment is provided which comprises a guiding rail configured to be mounted fixedly within a cabin of the vehicle and a movable curtain rail section for receiving and/or guiding a curtain, wherein the movable curtain rail section is configured to slide along the guiding rail to a desired position. The desired position is defined as a position on the guiding rail at which the movable curtain rail section shall be detachably fixed to the guiding rail. The guiding rail is mounted fixedly to a monument of the vehicle or to another space within the cabin by using screws or the like. The movable curtain rail section is attached to the guiding rail in a manner that it can slide along the guiding rail. Advantageously, the curtain rail section can be moved out of the way when necessary, i.e., in situations where maintenance work has to be performed, and back, i.e., after the maintenance work is finished.

The movable curtain rail section is retained in the desired position along the guiding rail by at least one movable end stop button being configured to slide along the guiding rail and being configured to engage with the guiding rail in order to fix the movable end stop button to the guiding rail in a locking position. The desired locking position of the movable end stop button is located adjacent to the desired position of the movable curtain rail section. In the locking position the movable end stop engages with the movable curtain rail section and the guiding rail. The movable end stop button is movable along the guiding rail together with the movable curtain rails section. When the desired position of the movable curtain rail section is reached at a position somewhere along the guiding rail, the at least one movable end stop button is positioned in its fixed state, i.e., the desired locking state, in which the at least one movable end stop button engages with the guiding rail and with the movable curtain rail section. The at least one end stop button is detachable from the fixed state. The locking and the unlocking of the end stop button can be performed without tooling. It is an advantage that even the crew can get access to the circuit breaker for example during a flight, if necessary.

The movable curtain rail section is movable along the at least one guiding rail between two fixed end stop buttons being mounted at the end pieces of the guiding rail and being configured to prevent the movable curtain rail section from being detached from the guiding rail. The two fixed end stop buttons prevent the movable curtain rail section from getting loose from the guiding rail. The fixed end stop buttons at the end pieces of the guiding rails provide safety in situations where the movable curtain rail section is sliding along the guiding rail and in case of a failure of the movable end stop buttons. It would also be possible to use screws for the fixed end stop buttons.

Preferably, the movable end stop buttons are configured to be in an unlocked state in which they are movable along the guiding section to the desired position and to be in a locked state in which they are detachably fixed in the desired position for retaining the movable curtain rail section in the desired position. In this way, the curtain can be arranged so that is gives as much comfort as possible to the crew and to the passengers of the vehicle, in particular of the aircraft.

Advantageously, the fixed and/or movable end stop button comprises a pin, in particular an index pin, configured for achieving a locked state and an unlocked state. The pin comprises a knob for achieving the unlocked state by using, preferably pushing or pulling, the knob and a spring for achieving automatically the locked state by spring load. Thus, the index pin comprises a knob, the use thereof results in the achievement of the unlocked state. In the unlocked state the pin, particularly the index pin, together with the curtain section are slidable along the guiding rail, in particular between the two fixed end stop buttons. Furthermore, the index pin comprises at least one spring, which provides a spring loading. The at least one spring is located within a hollow pin body, preferably a hollow cylindrical section of the pin body. The locked state is achieved automatically by spring loading. For achieving the locked state automatically it is, for example, sufficient to release the knob of the pin, which then will be spring loaded. In the locked state of the pin the pin, and particularly the curtain rail section positioned between two locked pins, are not movable along the guiding rail. At most the movable curtain rail section is only movable between the two locked movable pins, provided that the two locked movable pins are located a space apart from each other. The movable curtain rail section might then be only slidable along said space. Such a situation can be evoked, if it is needed that the movable curtain rail section remains movable along a defined section of the guiding rail. This section of the guiding rail is defined as “space” above. It is possible that the fixed end stop buttons are provided with screws, since the fixed end stop buttons need not to be operated. It is also possible that the fixed end stop buttons are provided as detachably fixable pins. The advantage of using a pin, in particular an index pin, for at least the movable end stop buttons is the usage thereof without extra tooling.

Advantageously, the vehicle cabin curtain rail attachment comprises a plurality of guiding rails that are mounted fixedly within the cabin, wherein the movable curtain rail section is attached between a pair of guiding rails. The pair of guiding rails are spaced apart from each other that the movable curtain rail section can be attached to the guiding rails easily. Thus, the spacing apart of the pair guiding rails corresponds essentially to the length of the movable curtain rail section. The pair of guiding rails are mounted within the cabin, essentially, parallel to each other. Providing the vehicle cabin curtain rail attachment with a pair of guiding rails improves the safety of the attachment as such.

Each guiding rail is provided with two fixed end stop buttons for preventing the movable curtain rail section from being detached from the guiding rail, wherein one of the fixed end stop buttons is positioned fixedly at each end piece of the guiding rail, and wherein at least one of the guiding rails comprises two movable end stop buttons configured to retain the movable curtain rail section at the desired position along the guiding rail. While two fixed end stop buttons are provided at the end pieces of a guiding rail, at least two movable end stop buttons are additionally provided which are slideable along the guiding rail together with the movable curtain rail section. The movable end stop buttons can preferably be operated without tooling and are provided at a position somewhere between the two fixed end-stop buttons. It is an advantage that even the crew can lock and unlock the movable end stop buttons during a flight, if necessary.

Preferably, each end piece of the movable curtain rail section is attached to one guiding rail by a guiding-rail-coupling means configured for guiding the movable curtain rail section along the guiding rail. By coupling the movable curtain rail section via guiding-rail-coupling means to the guiding rail, a secure guiding of the curtain rail section along or in the guiding rail(s) is available. The guiding-rail-coupling means can be mounted fixedly to the movable curtain rail section, while the mounting to the guiding rail is performed such that a slidable guidance along the guiding rail is achieved. Preferably, each of the guiding rails is provided with two tracks, between which the guiding-rail-coupling means is or are provided in a movable or slidable manner It is also possible that each of the guiding rails is provided with a slotted grove in which the guiding-rail-coupling means can slidably engage.

Furthermore, the vehicle cabin curtain rail attachment is provided with means of length compensation on at least one end region of one guiding rail in order to compensate in-motion deformations of the vehicle, preferably in-flight deformations of the aircraft fuselage structure, wherein the means of length compensation comprises a slotted hole. Especially in aircraft, during a flight the fuselage structure may deform due to changes in the external pressure and due to flight loads. Advantageously, the means of length compensation allows for compensating length deformations. The length compensation available corresponds to the length of the slotted hole. Such length compensation means can be provided at one end piece or at both end pieces of the movable curtain rail section.

Further advantageously, the vehicle cabin curtain rail attachment is provided with means of angle compensation on at least one end region of one guiding rail section in order to compensate in-motion deformations of the vehicle, preferably in-flight deformations of the aircraft fuselage structure, wherein the means of angle compensation comprises, preferably, a pin attachment configured to adjust an angle between the guiding rail and the movable curtain rail section. Preferably, to adjust an angle deviating from a 90 degree angle between an axis of the guiding rail and an axis of the movable curtain rail section being essentially perpendicular to each other when not deformed. Further preferably, the means of angle compensation comprises an axis of rotation via which the angle compensation is transmitted between the movable curtain rail section and the guiding rail(s). The axis of rotation is provided perpendicular to the axis along which the angle compensation is to be performed. With the angle compensation means any angle between 0 and 180 degrees, preferably ±90 degrees, can be compensated. Such angle compensation means can be provided at one end piece or at both end pieces of the movable curtain rail section. Preferably one angle compensation means is provided at one end piece while at the other end piece a length compensation means is provided. It is also possible that at the same end piece a length compensation means and an angle compensation means is provided.

Preferably a vehicle cabin curtain rail attachment is provided, wherein an L-shaped or a U-shaped curtain rail section is provided for connecting to at least one guiding rail, preferably for connecting to a pair of guiding rails. The L-shaped or U-shaped movable curtain rail section comprises at least two or three, preferably linear, movable curtain rail portions, that are coupled by curtain-rail-section-coupling means configured for shifting a curtain from one, preferably linear, curtain rail section to the adjacent curtain rail section. The curtain-rail-section-coupling means allows the transition of a curtain from one curtain rail section to the other. The curtain-rail-section-coupling means are mounted between at least two movable curtain rail sections detachably.

Of course, the curtain-rail-section-couplings means are adjustable into a locked state in which the curtain rail sections are detachably fixed with respect to each other and into an unlocked state in which the curtain rail sections are freely movable with respect to each other. In this way, the shape of the movable curtain rail section can be modified from being linear to being L-shaped or being U-shaped and back vice versa. In this way, the shape of the movable curtain rail section can be varied as much as needed, especially during a flight. This in turn enhances the comfort provided by a curtain provided in a vehicle cabin curtain rail attachment. The curtain-rail-section-couplings means comprises a knob for achieving the unlocked state and a spring for achieving the locked position automatically by spring load. In this way, the crew can without tooling vary the shape of movable curtain rail section.

### BRIEF DESCRIPTION OF THE DRAWINGS

Preferred embodiments of the vehicle cabin curtain rail attachment, in particular for an aircraft, are described in greater detail with reference to the attached schematic drawings in the following, wherein

FIG. 1 shows a top view of the vehicle cabin curtail rail arrangement according to the present invention in the normal position, for example during a flight,

FIG. 2 shows a top view of the vehicle cabin curtail rail arrangement according to the present invention in the access position, for example during maintenance work,

FIG. 3 shows a side view of the vehicle cabin curtail rail arrangement according to the present invention,

FIGS. 4a, b show two possible positions of the movable curtain rail section,

FIGS. 5a, b show two possible further positions of the movable curtain rail section,

FIG. 6 shows an index pin in perspective side views,

FIGS. 7a, b show a side view of the index pin mounted in the vehicle cabin curtail rail arrangement in the locked state (FIG. 7a) and the unlocked state (FIG. 7b), and

FIGS. 8a, b show means of length compensation (FIG. 8a) and means of angle compensation (FIG. 8b).

### DETAILED DESCRIPTION OF THE PREFERRED EMBODIMENTS

The following detailed description of the schematic drawings focuses on the illustrated implementation variants of a vehicle cabin curtain rail attachment, in particular for an aircraft. The present disclosure is not limited to the above and below described and illustrated vehicle cabin curtain rail attachment, but includes combinations of the described variants and implementation details of these vehicle cabin curtain rail attachments.

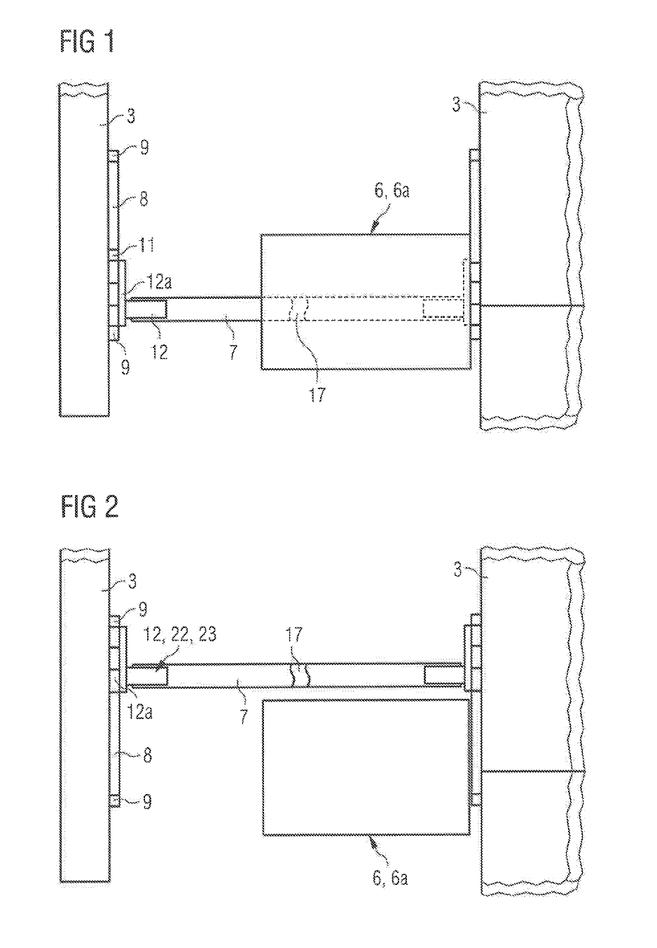

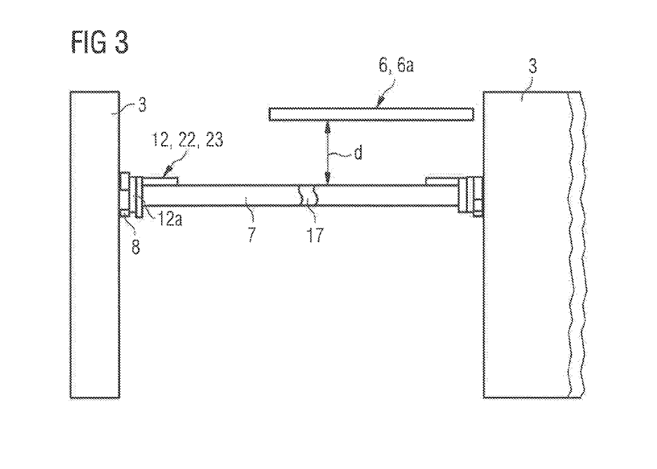

FIG. 1 shows a top view of the cabin curtain rail attachment 1 according to the present invention. A movable curtain rail section 7 is mounted between two guiding rails 8. Each guiding rail 8 is provided with a fixed end stop button 9 at the end pieces 10 of the guiding rails 8 preventing the movable curtain rail section from being detached. The movable curtain rail section 7 is in its normal position as shown in FIG. 3 just located below the circuit breaker panel 6 and/or the plexiglass cover 5 respectively. A movable end stop button 11 is used to position the movable curtain rail section in a desired position. The movable end stop button 11 can be brought into a locked and an unlocked state. In the locked state the movable end stop button 11 prevents the movable curtain rail section 7 from sliding along the guiding rail 8, while in the unlocked state a sliding of the movable curtain rail section 7 is possible. The guiding rails 8 are mounted on monuments 3 of the aircraft 4. Monuments 3 are for example partitions or the galleys, in which the trolleys are usually stored when the catering work is done. The movable curtain rail section 7 is coupled to the guiding rail 8 by guiding-rail-coupling means 12 that comprises sliding means 12a. The sliding means 12a of the guiding-rail-coupling means 12 are provided with the guiding rail 8 while the rest of the guiding-rail-coupling means 12 are provided with at least on end region of the movable curtain rail section 7. The guiding-rail-coupling means 12, in particular the sliding means 12a, are configured for guiding the movable curtain rail section 7 along the guiding rail 8, i.e. for transmitting the sliding movement of the movable curtain rail section 7 along the guiding rail 8.

FIG. 2 shows in top view the cabin curtain rail attachment 1 of FIG. 1, but in an access position in which maintenance work can be done easily. In the access position shown in FIG. 2 the movable curtain rail section 7 is moved along the guiding rails 8 away from the circuit breaker panel 6 and the plexiglass cover 5. For doing so, the movable end stop button(s) 11 is/are released from its locked state and is/are moved in its unlocked state along the guiding rail(s) 8. As a result the plexiglass cover 5 of the circuit breaker panel 6 is openable fully such that maintenance work can be done easily.

FIG. 3 shows a side view of the cabin curtain rail attachment 1 according to the cabin curtain rail attachment 1 shown in FIGS. 1 and 2. In the side view of FIG. 3 it becomes clear that in the normal position, the plexiglass cover 5 of the circuit board panel 6 is only openable along a distance d, until the plexiglass cover reaches the movable curtain rail section 7. According to the present invention however, the plexiglass cover 5 can be opened completely, since in the access position as shown in FIG. 2 the movable curtain rail section 7 is moved out of the way.

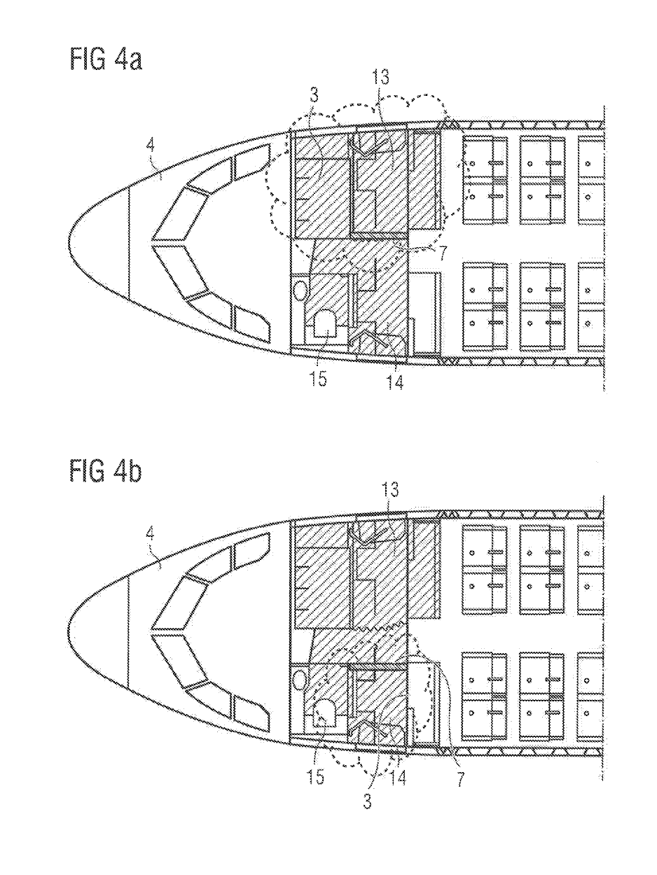

FIGS. 4a, b and 5a, b show how the curtain 2 could be provided with the proposed cabin curtain rail attachment 1 within a cabin. By using a lateral linear movable curtain rail section 7, the crew of the aircraft 4 is able to re-dedicate certain areas in the cabin based on the current flight phase. By using the proposed tool-less locking/unlocking principles the variations of providing the curtain 2 within the cabin shown in FIGS. 4a, b and 5a, b are possible without support of a maintenance crew.

For example, during boarding or during catering activities inside the galley area 13 comprising monuments 3, the curtain 2 provided on the movable curtain rail section 7 will separate the galley 13 from the rest of the cabin (see FIG. 4a). During flight and after catering activities a crew resting area 14 can be separated from the rest of the cabin while the lavatories 15 are still accessible, e.g., on long-haul flights (see FIG. 4b). The cabin curtain rail attachment 1 is, for example, attached to a, or a plurality, of monuments 3.

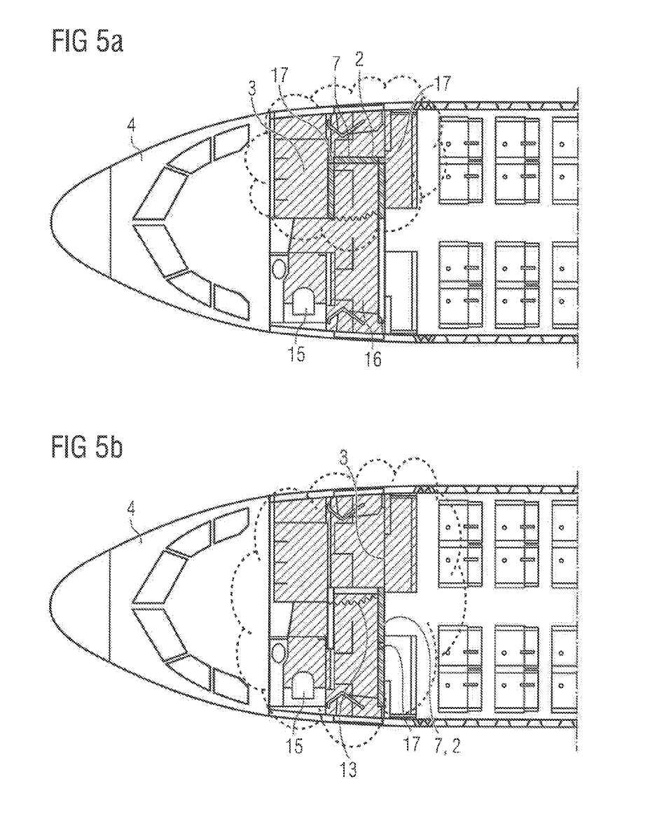

If a U-shaped movable curtain rail section 7 as shown in FIG. 5a is used, the crew is able to create a larger and more aesthetical reception area 16 during boarding, as the working areas of the galley area 13 would be hidden by the curtain 2 (see FIG. 5a). During catering activities the galley area 13 can be separated from the rest of the cabin. The over length of the curtain can be pulled towards an area where the curtain 2 does not disturb the crew activities (see FIG. 5b). It is possible to provide the movable curtain rail section 7 in L-shape. For providing the transition between a U-shaped (or L-shaped) movable curtail rail section 7 of FIG. 5a to a linear movable curtain rail section 7 of FIG. 5b, curtain-rail-coupling means 17 need to be unlocked. The curtain-rail-coupling means 17 can be in a locked state in which they may provide a U-shape or L-shape or a linear shape to the movable curtain rail section 7. When the curtain-rail-coupling means 17 are unlocked, the movable curtain rail sections 7 can be brought into position and locked afterwards. For example, the curtain-rail-coupling means 17 can comprise tool-less pins with which an unlocking and a locking can be performed easily.

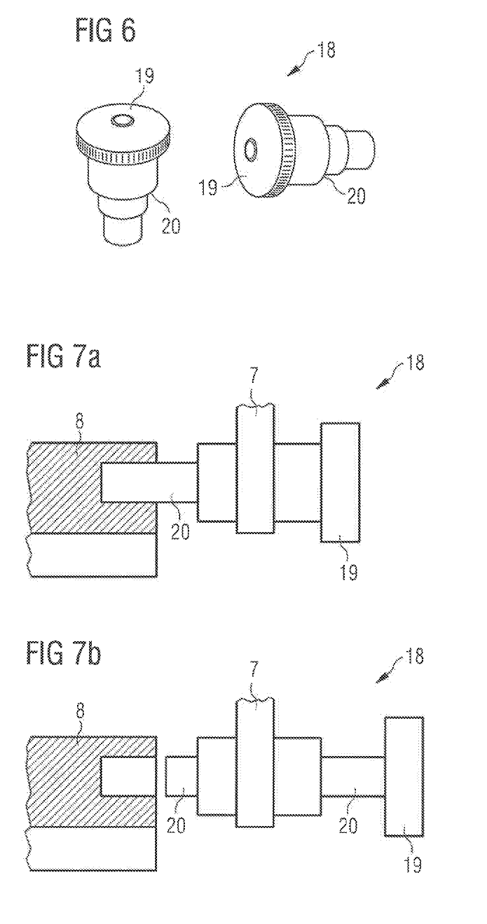

FIG. 6 shows in a perspective view an index pin 18. The index pin 18 is provided with a knob 19 and a hollow cylindrical body 20 in which a spring (not visible) is housed. The index pin 18 can be operated tool-less. By pushing or pulling the knob 19, the index pin 18 will reach the unlocked state presented in FIG. 7a. Due to the spring, the index pin 18 will reach automatically the locked state presented in FIG. 7b due to the spring loading, preferably when the knob is released. Due to the spring loading of the spring that is retained within the hollow cylindrical body 20, the spring is automatically pressed against a surface or a recess provided with a surface with which the cylindrical body 20 that is housing the spring can abut. The abutting of the cylindrical body 20 on a surface generates an abutting force that is acting in a direction opposed to the direction of a spring loading force. The automatically reaching of the locked state is due to the equilibrium of the spring loading force and the abutting force. FIGS. 7a, b show the index pin 18 when it is mounted within the cabin curtain rail attachment 1. Such pins, preferably index pins, can be used for the guiding-rail-coupling means 12 coupling an end region of the movable curtain rail section 7 to the guiding rail 8, as well as for the curtain-rail-coupling means 17 inter-connecting at least two movable curtain rail sections 7. The shape of the index pin 18 can vary from the index pin shown in FIG. 6.

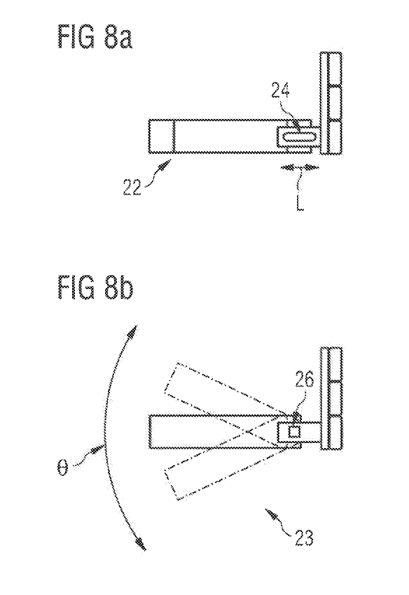

FIGS. 7a, b show the index pin 18 when it is mounted within the cabin curtain rail attachment 1. For example, according to FIGS. 7a, b, the movable curtain rail section 7 is provided with at least one hole through which the cylindrical body 20 of the index pin 18 is inserted. Furthermore, the guiding rail 8 is provided with at least one recess or a hole, in which the cylindrical body 20 of the index pin 18 is engaging in the locked state (FIG. 7a) and from which it is released in the unlocked state. FIGS. 10a, b show means of length compensation 22 (FIG. 8 a) and means of angle compensation 23 (FIG. 8 b). The means of length compensation 22 and/or the means of angle compensation 23 are comprised in the guiding-rail-couplings means 12 (shown in FIGS. 1, 2, and 3). The means of length compensation 22 are provided with a slotted hole 24. The length of the slotted hole 24 provides a compensation length L along a direction that is essentially parallel to the movable curtain rail section 7. The means of angle compensation 23 are provided with a rotating pin axis 26 that allows the rotation of the movable curtain rail section 7 by an angle Θ of between 0 and 180 degrees between the movable curtain rail section 7 and the guiding rail 8. For example, in FIG. 8b an angle Θ of approximately 60, 90 and 120 degrees between the movable curtain rail section 7 and the guiding rail 8 is demonstrated schematically. The means of length compensation 22 are provided on at least one side of the at least one guiding rail 8 in order to compensate in-motion deformations of the vehicle, preferably in-flight deformations of the aircraft fuselage structure. The slotted hole 24 is provided with a length L along which the length compensation can be performed. The means of angle compensation 23 are provided on at least one side of one guiding rail 8 in order to compensate in-motion deformations of the vehicle, preferably in-flight deformations of the aircraft fuselage structure, wherein the means of angle compensation 23 comprises the pin attachment 26 configured to adjust the angle between the guiding rail 8 and the movable curtain rail section 7.

The cabin curtain rail attachment according to the embodiments presented above can be installed on the pelmet or behind the pelmet of a monument 3. The description above is made with respect to an aircraft however this shall not limit the scope of the present invention to aircraft. Instead, the vehicle cabin curtain rail attachment can be provided to any vehicle, for example such as a train, a bus, etc.

The above described aspects, variants and implementations of a vehicle cabin curtain rail arrangement do not limit the present disclosure. Any details described with respect to one of the illustrated embodiments may also be implemented or applied to another one of the described embodiments.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE LIST

1 cabin curtain rail attachment
2 curtain
3 monument
4 aircraft
5 plexiglass cover
6 circuit breaker panel
7 movable curtain rail section
8 guiding rail
9 fixed end stop button
10 end piece (of the guiding rail)
11 movable end stop button
12 guiding-rail-coupling means
12a sliding means
13 galley area
14 crew area
15 lavatory
16 aesthetical reception area
17 curtain-rail-coupling means
18 index pin
19 knob
20 cylindrical body
21 end side (of the movable curtain rail section)
22 length compensation means
23 angle compensation means
24 slotted hole
25 length
26 pin attachment having a rotation pin axis
d distance
L compensation length
Θ angle

1. A vehicle cabin curtain rail attachment comprising:
a guiding rail configured to be mounted fixedly within a cabin of the vehicle, and
a movable curtain rail section for at least one of receiving or guiding a curtain,
the movable curtain rail section being configured to slide along the guiding rail to a desired position.

2. The vehicle cabin curtain rail attachment according to claim 1, wherein the movable curtain rail section is retained in the desired position along the guiding rail by at least one movable end stop button being configured to slide along the guiding rail and being configured to engage with the guiding rail in order to fix the movable end stop button to the guiding rail in a locking position.

3. The vehicle cabin curtain rail attachment according to claim 2, wherein the movable curtain rail section is movable along the at least one guiding rail between two fixed end stop buttons being mounted at end pieces of the guiding rail and being configured to prevent the movable curtain rail section from being detached from the guiding rail.

4. The vehicle cabin curtain rail attachment according to claim 2, wherein the movable end stop buttons are switchable between an unlocked state in which they are movable along the guiding section to the locking position and a locked state in which they are detachably fixed in the locking position for retaining the movable curtain rail section in the desired position.

5. The vehicle cabin curtain rail attachment according to claim 2, wherein the end stop button comprises a pin configured for achieving a locked state and an unlocked state.

6. The vehicle cabin curtain rail attachment according to claim 5, wherein the pin comprises an index pin.

7. The vehicle cabin curtain rail attachment according to claim 5, wherein the pin comprises a knob for achieving the unlocked state by using the knob, and a spring for achieving automatically the locked state by spring load.

8. The vehicle cabin curtain rail attachment according to claim 7, wherein the knob is configured to be pushed or pulled to achieve the unlocked state.

9. The vehicle cabin curtain rail attachment according to claim 1, wherein a pair of guiding rails is configured to be mounted fixedly within the cabin, wherein the movable curtain rail section is attached between the two guiding rails of said pair.

10. The vehicle cabin curtain rail attachment according to claim 1, wherein a plurality guiding rails is provided, each thereof with two fixed end stop buttons for preventing the movable curtain rail section from being detached from the guiding rail, wherein the fixed end stop buttons are positioned fixedly at each end piece of the guiding rail, and wherein at least one of the guiding rails comprises two movable end stop buttons configured to retain the movable curtain rail section at the desired position along the guiding rail.

11. The vehicle cabin curtain rail attachment according to claim 1, wherein each end piece of the movable curtain rail section is attached to one guiding rail by a guiding-rail-coupling configured to guide the movable curtain rail section along the guiding rail.

12. The vehicle cabin curtain rail attachment according to claim 1, wherein a slotted hole is provided on at least one end region of at least one guiding rail in order to compensate in-motion deformations of the vehicle.

13. The vehicle cabin curtain rail attachment according to claim 1, wherein a pin attachment configured to adjust an angle between the guiding rail and the movable curtain rail section is provided on at least one end region of one guiding rail in order to compensate in-motion deformations of the vehicle.

14. The vehicle cabin curtain rail attachment according to claim 13, wherein the pin attachment is configured to adjust an angle deviating from a 90 degree angle between an axis of the guiding rail and an axis of the movable curtain rail section being essentially perpendicular to each other when not deformed.

15. The vehicle cabin curtain rail attachment according to claim 1, wherein an L-shaped or a U-shaped movable curtain rail section is provided for connecting to at least one guiding rail.

16. The vehicle cabin curtain rail attachment according to claim 15, wherein the movable curtain rail section is provided for connecting to a pair guiding rails.

17. The vehicle cabin curtain rail attachment according to claim 15, wherein the L-shaped or U-shaped movable curtain rail section comprises at least two movable curtain rail portions, that are coupled by curtain-rail-section-coupling means configured to support the shifting of the curtain from one movable curtain rail section to the adjacent movable curtain rail section.

18. The vehicle cabin curtain rail attachment according to claim 17, wherein the movable curtain rail portions are linear and the movable curtain rail section and the adjacent movable curtain rail sections are linear.

19. The vehicle cabin curtain rail attachment according to claim 17, wherein the curtain-rail-section-couplings means are adjustable into a locked state in which the movable curtain rail sections are detachably fixed with respect to each other and into an unlocked state in which the movable curtain rail sections are freely movable with respect to each other.

20. The vehicle cabin curtain rail attachment according to claim 17, wherein the curtain-rail-section-couplings comprises a knob for achieving the unlocked state and a spring for achieving the locked position automatically by spring load.
